(19) United States
(12) Patent Application Publication
(10) Pub. No.: US 2009/0327095 A1
(43) Pub. Date: Dec. 31, 2009

(54) System and method for conducting transactions without return policies

(76) Inventor: Fan Zhang, Dunwoody, GA (US)

Correspondence Address: Fan Zhang, 4810 Ashford Lane, Dunwoody, GA, 30338, US

(21) Appl. No.: 12/215,840

(22) Filed: Jun. 30, 2008

(51) Int. Cl. G06Q 20/00; G06Q 30/00; G06Q 50/00; G06Q 10/00

(52) U.S. Cl. 705/26; 705/39; 705/40; 705/30

(57) ABSTRACT

A transaction system includes an item database that stores one or more items as logical groupings of digital contents and their associated prices; and a user database operable to store information associated with one or more users. The transaction system also includes a transaction engine that receives purchase fund equal to the price of an identified item from a buyer for purchasing the item. The transaction engine then receives numeric rating from the buyer within a rating period after the purchase, or applies a default rating when the rating period expires and the rating has not been received. After the rating is decided, the transaction engine pays the seller a portion, all or none included and proportional to the rating, of the purchase fund minus any fee. The transaction engine distributes the residual fund to one or more third parties to complete the transaction.

### BACKGROUND OF THE INVENTION

1. Field of the Invention

This invention relates generally to the field of product and service transactions, and more particularly to a system and method for conducting transactions involving no return policies.

2. Prior Art

With the growth of Internet, Internet commerce also boomed. For trading tangible goods, there are many success stories, and companies like Amazon and eBay have become household names. In essence, their business model is about using the Internet to extend the reach of traditional ‘brick and mortar’ based shops.

On the other hand, even though the amount of digital contents has experienced almost exponential growth, Internet commerce involving digital contents has been done mostly through an indirect way, namely the exposure-based model of giving free access to digital contents and making profits by selling ads attached to the digital contents. Google and Yahoo have been the greatest success stories in that arena. But when digital contents need to be valuated individually, this model is still inadequate. Subscription-based model has the same limitation.

A computer program can be traded directly online by using a digital key to allow evaluation for a predetermined timeframe; a song can be traded online by providing a free clip of the song for evaluation. These are a few examples involving direct trading of digital contents; but they have limited scopes and can hardly be extended to cover direct trading of other forms of digital contents, e.g. an answer to a question, a solution to a problem, a business lead, a custom design, a translation of a document, a legal opinion, etc.

One of the main difficulties of trading digital contents is the difficulty of allowing customers to evaluate digital contents without giving the contents away. With physical goods, a return policy can be an assurance to buyers and is usually not detrimental to the sellers. But with digital or intangible goods, a similar policy is hard to implement. In most cases, if the customers are allowed to look at a digital content, the need to buy it disappears, because copies of digital contents are easy to make and ideas in a human brain are impossible to erase by demand. So for digital contents, with a return policy, the financial risks would be all on the sellers, and without it, the financial risks would be all on the buyers.

A closer look has revealed that the difficulty involving direct trading of digital contents is caused by disadvantages of transaction systems heretofore known:
a) Buyers are reluctant to purchase a digital content without a satisfaction guarantee from the seller that keeps the seller honest.
b) Sellers are reluctant to offer any satisfaction guarantee because there is no way, or at least no easy way, of truly returning a digital content sold, and no way of preventing buyers from claiming dissatisfaction for financial gains.
c) Even when a buyer can be sure the seller has the best intension based on a seller's rating and track history, it is still hard for a buyer to make a purchase decision before having full access to a digital content.
d) Because typically transaction fees associated with a financial transaction are in the ranges of tens of cents, it is hard to trade digital contents that are priced not much higher than fees associated with a transaction.

3. Objects and Advantages

One company that has attempted to address the above-mentioned problems is BorrowYourBrain.com. By using the system and method of this invention, BorrowYourBrain.com promotes the direct trading of digital contents by keeping a fair balance between the risks of a buyer versus those of a seller during a trade, by aligning a buyer and a seller's interests so that they both gain in a successful trade and both lose in an unsuccessful trade, by lowering the negative impact of a bad trade through donation, and by facilitating micro-transactions.

Several objects and advantages of the present invention are:
a) to give buyers a leverage over sellers to keep sellers being honest when purchasing without a return policy;
b) to not cause sellers' concerns about buyers abusing any leverage over sellers;
c) to lower the negative impact of a bad trade;
d) to lower transaction cost and to facilitate micro-transactions.

### SUMMARY OF THE INVENTION

Since in many situations it's almost impossible to truly assess the value of a piece of digital content before having full access to it, if a seller gets paid regardless of a buyer's satisfaction, overpricing or even cheating could occur at a rate that deters potential buyers. On the other hand, if a buyer can claim dissatisfaction and pay less, and still keep the purchased item because there is no way of getting a true return, a seller would probably be seriously discouraged to sell. It's an old dilemma when it comes to trading digital contents. Now, if a buyer pays a fixed amount regardless of the level of satisfaction, and a seller gets paid based on the buyer's level of satisfaction, that dilemma is broken. Furthermore, when a seller is paid less than what a buyer pays minus any fees, a portion or all of the difference goes to charities. So even though there are still risks associated with buying digital contents, but that kind of risks has changed from losing money to donating money. Since many people love to donate to their cherished causes, from their perspective, that risks are mitigated.

According to the present invention, after an item has been identified, the buyer pays the full price to the host of the transaction system when purchasing an item; the buyer is given a rating period within which the buyer can give a rating about the purchase; the transaction system applies a default rating to the purchase when the rating period expires and no rating has been given by the buyer; when the rating of a purchase is decided, a portion from zero percent to a hundred percent of the full price, or of the full price minus transactions fees, proportional to the rating according to a predetermined formula will be paid to the seller; the residual fund will be paid to one or more third parties, some or all of them charity organizations; the transaction system thus completes a transaction.

The advantages are realized through these means:
a) Buyers have the leverage to keep sellers honest because buyers decide how much sellers actually get paid.
b) Sellers know buyers have no financial incentives to claim dissatisfaction because buyers pay the same amount regardless of levels of satisfaction.
c) Buyers are less concerned about losing money in a bad trade when a good portion of that money goes to charity organizations.
d) Average transaction costs are greatly lowered by minimizing the number of connections made to external financial organization and using stored credits to transact.

The invention is extended to cover the transactions of not only digital contents but also physical goods and services.

### BRIEF DESCRIPTION OF THE DRAWINGS

To provide a more complete understanding of the present invention and further feathers and advantages thereof, reference is now made to the following description taken in conjunction with the accompanying drawings, in which:

FIG. 1 illustrates an exemplary transaction system incorporating teachings of the present invention;

FIG. 2 illustrates an exemplary method for conducting a transaction using the transaction system.

FIG. 3 illustrates an exemplary breakdown of how fund used to purchase an item is paid to various parties in regard to an exemplary satisfaction-rating scheme;

### DETAILED DESCRIPTION OF THE INVENTION

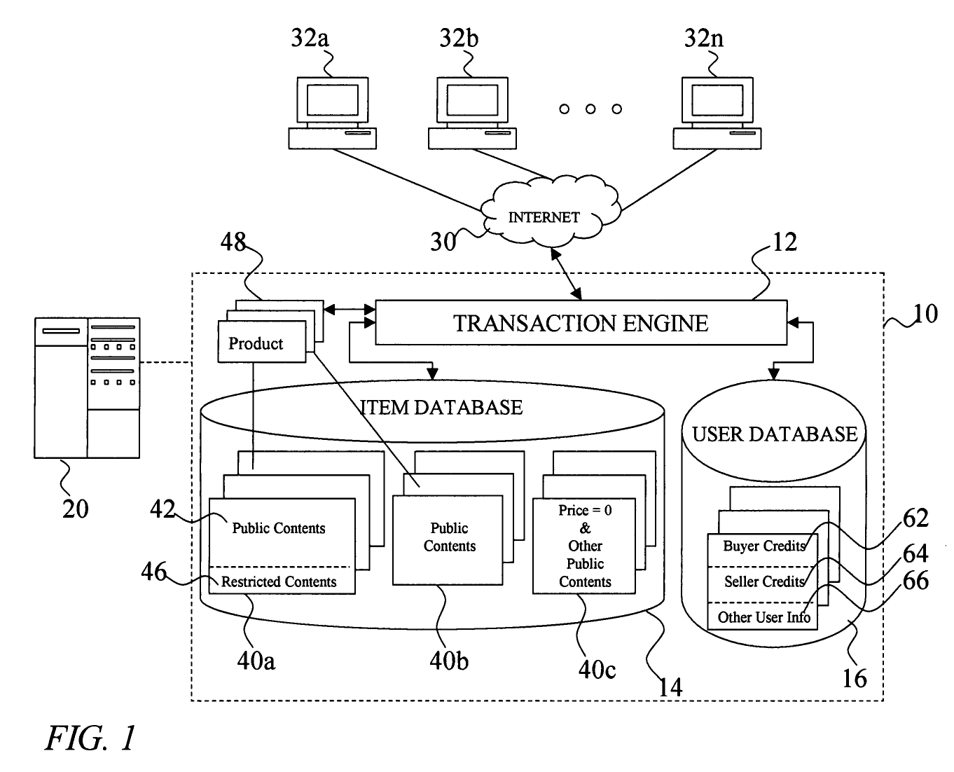

FIG. 1 illustrates an exemplary transaction system 10 incorporating teachings of the present invention. Transaction system 10 includes a transaction engine 12 that receives an item listing request, communicates item listings to a user, receives fund from a user for purchasing an item, delivers an item and/or an associated product when necessary, receives satisfaction rating from the buyer about a purchase, pays the seller according to the buyer's rating of the purchase, distributes the rest of the fund to third parties, and concludes the transaction.

Transaction engine 12 is coupled to an item database 14 that stores one or more items and their associated information. The term “item” should be understood as a logical grouping of digital contents belonging to a user for transaction or discussion purposes within the transaction system 10. An item's public contents 42 are accessible to the public and restricted contents 46 are accessible only to the owner of the item, and users who have purchased the item and if there is an access time limit it has not expired yet. Besides an item's restricted contents 46, an item's price could cover other tangible or intangible goods or services that need to be delivered when this item is purchased. The grouping of tangible and intangible goods and services associated with an item that needs to be delivered when the item is purchased is referred to as an associated “product” 48. A product 48 could be internal to the transaction system 10 or it could be handled externally which is not depicted in FIG. 1. There are three kinds of items: items 40a that include a price, other public contents, and restricted contents 46; items 40b that only include a price and other public contents; and items 40c that include only public contents 42 either without a price or a price that's always 0. An item 40c cannot be traded and is likely for discussion purposes only. Both items 40a and items 40b can be traded. An item 40b should have an internal or external associated product. An item 40a can also have an associated product.

Transaction engine 12 is also coupled with a user database 16 that stores information about users of transaction system 10. A user can play the roles of buying or selling and can be referred to as a “buyer” or “seller” when appropriate. User database 16 can stored a user's buyer credits 62, seller credits 64, and other user info 66. A user's buyer credits 62 are a fund available to the user that can be used as purchase fund during purchases. Here “purchase fund” is referred to as the fund the buyer pays for making the purchase and is equal to the price of the item set by the seller. A user's seller credits 64 are a fund the user has earned as a seller and can be withdrawn upon request. Transaction engine 12 allows a user to convert a portion or all of the user's buyer credits 62 to the user's seller credits 64 and vise versa, with or without a fee. A special case of the above description is to allow a user's seller credits 64 be used as purchase fund and a user's buyer credits 62 be withdrawn upon request, thus combines a user's buyer credits 62 and seller credits 64 into a user's stored credits that serves both purposes.

Transaction engine 12, item database 14, and user database 16 may be implemented together or separately as software and/or hardware that operates on one or more computer servers 20 at one or more locations.

Transaction system 10 may be coupled to the Internet 30 or any other suitable wireline or wireless network that supports communications between one or more computers 32a-32n and transaction system 10. In a particular embodiment, transaction system 10 includes Hypertext markup Language (HTML) documents, emails, or other suitable documents that may be communicated over Internet 30 for display on computers 32. The term “Web pages” will be used to encompass HTML documents and any other appropriate techniques of displaying contents using Internet 30, such as Extensible Market language (XML) documents. Computer 32 may include interfaces, Web browsers, email readers or any other hardware, software or other components to facilitate connection to Internet 30 and display of Web pages.

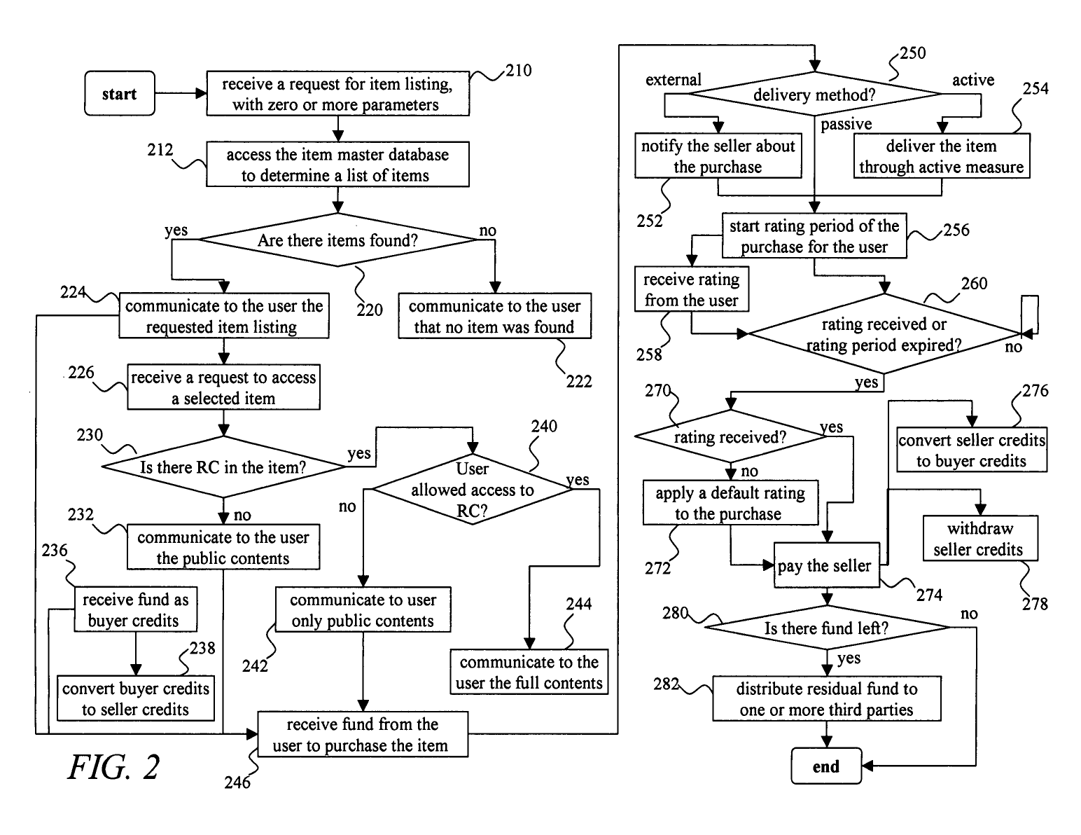

FIG. 2 illustrates an exemplary method for performing a transaction using transaction system 10. The method starts at step 210 when transaction engine 12 receives a request for item listing with zero or more parameters that the item being listed must meet. Parameters can be used to limit the scope of the listing and in some circumstances people may prefer to use the term “searching” instead of “listing” to describe the action, but in essence, searching is a kind of listing and “listing” in step 210 is used in a broad sense. When no parameter is given, it is considered equivalent of a situation that every item meets an empty parameter. Examples of “a parameter” include but not limited to a category, a string of keywords, a timeframe, a price range, and any other contents or information that can be part of or associated with an item. The request for listing may be communicated over Internet 30 from a user at a computer 32, or may be received by transaction engine 12 through any other appropriate manner, which includes but not limited to phone calls or even postal mails. At step 212, transaction engine 12 determines one or more items that meet zero or more parameters by accessing information stored in the item database 14 and/or user database 16. If transaction engine 12 determines at step 220 that no items meet the parameters, then transaction engine 12 communicates a message to the user at step 222 indicating that no items meeting the request are available. The method may then end and transaction engine 12 may allow the user to try another listing request.

If transaction engine 12 determines at step 220 that one or more items meet the parameters of the request, then transaction engine 12 communicates a list of items to the user at step 224. The list of items should be identifiable by a name, an id, or a Web link so that a user can make a selection. Transaction system 12 may then receive a request to gain access to an item at step 226. If at step 230 transaction engine 12 determines the requested item is an item 40b or an item 40c that does not include restricted contents (RC) 46, transaction engine 12 communicates the public contents of the requested item to the user at step 232. Otherwise transaction engine 12 concludes that the item is an item 40a and needs to further determine at step 240 whether the requesting user should have access right to the restricted contents (RC) 46. Transaction engine 12 accesses the user database, possibly in conjunction with the item database and other databases to make that determination. If at step 240 transaction engine 12 determines that the user does not have the access right, transaction engine 12 communicates to the user only the item's public contents and informs the user the existence of restricted cosntents at step 242, otherwise transaction engine 12 communicates both public and restricted contents of the item to the user at step 244.

At step 246 the user makes a choice to purchase an identified item by transferring a fund equal to the price of the item to the hosting company or another party acting on the hosting company's behalf. Transaction engine 12 will record the purchase with user database 16 and possibly in conjunction with item database 14 or other databases. The fund can be transferred in numerous ways, including but not limited to credit card charges, third party payment gateways like PayPal, wired transfer, checks, cash, or even buyer credits 62. At step 246 transaction engine 12 can deduct any fees on behalf of the hosting company or one or more other parties involved in the transaction directly or indirectly. In an exemplary embodiment, a fee can be deducted on behalf of the seller so that the seller is guaranteed a portion of the purchase fund. What is left in a purchase fund after deducting all fees is referred to as “withheld fund”.

In order to lower transaction costs associated with fund transfers involving external parties, in an exemplary embodiment, at step 236 transaction engine 12 allows a user to add fund similar to step 246 but before identifying an item to purchase, and stores the fund as buyer credits to be used later. Because step 236 is not tied to purchasing a particular item, a user may add fund in an amount not bound by the price of any item. At step 238 transaction engine 12 can convert a portion or all of a user's buyer credits 62 into seller credits 64 upon the user's request, with or without a fee.

There are three ways of delivering an item 40 and its associated product 48. At step 250, if transaction engine 12 determines that the delivery method is “external”, meaning transaction engine 12 is not responsible for the delivery, at step 252 transaction engine 12 will notify the seller of the purchase with enough information about the buyer so that the seller can take care of the delivery. If at step 250 transaction engine 12 determines the delivery method is “active”, at step 254 transaction engine 12 will either communicate to the user the restricted contents of the item, or deliver to the user the item's associated product, or both. At step 254, the delivery method could involve but not limited to Web pages, emails, phone calls, postal mails, etc. If at step 250 transaction engine 12 determines that the delivery method is “passive”, transaction engine 12 needs to do nothing explicitly about the delivery because the purchase has been recorded and the buyer now has the right to access the restricted contents of the purchased item at the buyer's request.

After delivery is handled from transaction system 10's perspective, at step 256, transaction engine 12 starts the rating period of the purchase for the buyer. Within this rating period, the buyer can give a satisfaction rating of the purchase at step 258. The rating can be communicated through Web pages, emails, phone calls, postal mails, or any other reasonable means. At step 260 transaction engine 12 keeps track of the time since the item has been purchased until either a rating of the purchase is received or the rating period expires. At step 270 if transaction engine 12 determines that no rating has been received, transaction system 12 will apply a default rating to the purchase before proceeding to the next step 274, otherwise transaction engine 12 proceeds directly to the next step 274.

After the rating has been determined, at step 274 transaction engine 12 uses withheld fund to pay the seller according to the buyer's rating. Step 274 can happen immediately when the rating has been determined, or it can still wait until the rating period expires to allow the buyer to make corrections to the rating. The rating is a numeric value or equivalent, and transaction engine 12 pays the seller a portion of the withheld fund proportional to the rating's numeric value. After paying the seller at step 274, what is left in the withheld fund is referred to as the “residual fund”. At step 274 payments can be made to the seller through means including but not limited to a check, a credit card transfer, a wired transfer, or seller credits 64. A seller can request transaction engine 12 to convert a portion or all of the seller credits 64 to buyer credits 62 at step 276, with or without a fee. A seller can also request transaction engine 12 to withdraw a portion or all of the seller credits 64 at step 278.

At step 280, transaction engine 12 determines if residual fund is greater than zero. If the answer is no, transaction engine 12 completes the transaction, otherwise at step 282 transaction engine 12 distributes the residual fund to one or more third parties and then completes the transaction. The terms “third parties” means any party other than the buyer and the seller. In an exemplary embodiment, transaction engine 12 at step 282 will always distribute residual fund to one or more charity organizations.

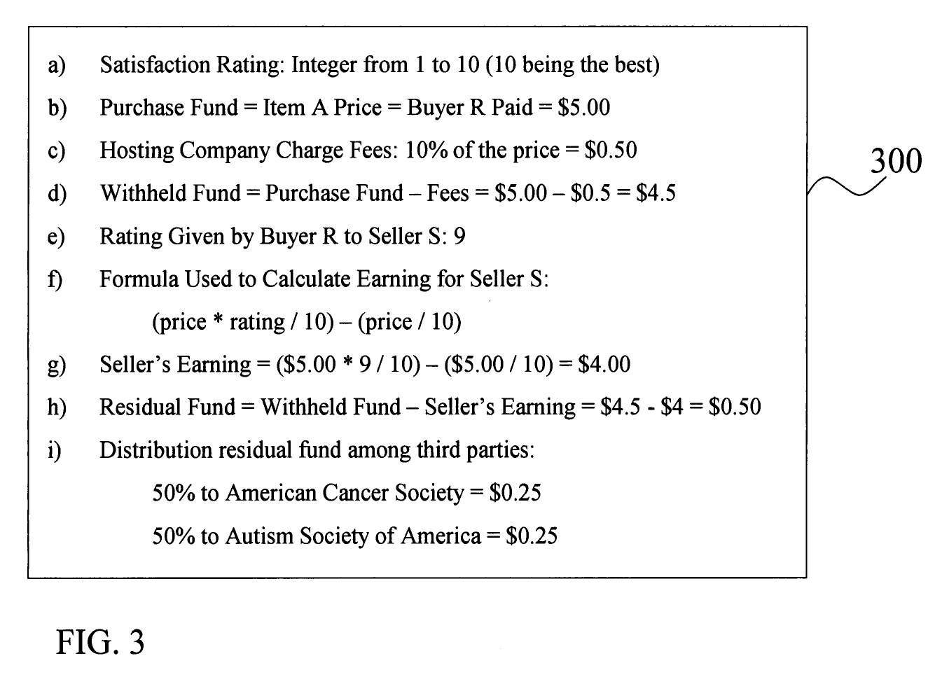

FIG. 3 illustrates an exemplary way of how purchase fund is paid to various parties in regards to an exemplary rating scheme.

Although the present invention has been described with several embodiments, numerous changes, substitutions, variations, alterations, and modifications may be suggested to one skilled in the art, and it is intended that the invention encompass all such changes, substitutions, variations, alterations, and modifications as fall with in the spirit and scope of the appended claims.

What is claimed is:

1. A transaction system, comprising:
an item database operable to store one or more items as logical groupings of digital contents, and their associated prices;
a user database operable to store information associated with one or more users; and
a transaction engine operable to:
receive fund equal to the price of an identified item from a buyer for purchasing the item;
receive a numeric or equivalent satisfaction rating about a purchase from the buyer within a rating period and access user database in conjunction with item database to record the rating;
apply a default rating to a purchase when the rating period expires and no rating has been received from the buyer;
pay the seller a portion, zero and a hundred percent included and proportional to the rating, of the withheld fund after a rating becomes available;
distribute the residual fund to one or more third parties to complete the transaction.

2. The transaction system of claim 1, wherein the transaction engine is further operable to:
receive a request for item listing, the request includes zero or more parameters;
access the item database to determine a list of items;
communicate to a user the requested item listing;

3. The transaction system of claim 1, wherein the transaction engine is further operable to:
receive a request to access an item from a user;
access item database and user database to obtain the contents accessible to the user;
communicate to the user the contents accessible to the user.

4. The transaction system of claim 1, wherein the transaction engine is further operable to notify the seller when a buyer makes a purchase.

5. The transaction system of claim 1, wherein the transaction engine is further operable to actively deliver to the buyer any portion of both an item's restricted contents and a possible associated product after a buyer purchases an item.

6. The transaction system of claim 1, wherein all third parties are charity organizations.

7. The transaction system of claim 1, wherein user database is further operable to store buyer credits and seller credits associated with one or more users; and the transaction engine is further operable to:
receive fund from a user to be stored as buyer credits;
receive fund from a buyer through buyer credits equal to the price of an identified item for purchasing the item;
pay the seller as seller credits a portion, zero and a hundred percent included and proportional to the rating, of the withheld fund after a rating becomes available;
pay a user any portion of the user's seller credits upon the user's request;
convert any portion of buyer credits into seller credits upon the user's request;
convert any portion of seller credits into buyer credits upon the user's request.

8. The transaction system of claim 1, wherein user database is further operable to store stored credits associated with one or more users; and the transaction engine is further operable to:
receive fund from a user to be stored as stored credits;
receive fund from a buyer through stored credits equal to the price of an identified item for purchasing the item;
pay the seller as stored credits a portion, zero and a hundred percent included and proportional to the rating, of the withheld fund after a rating becomes available;
pay a user any portion of the user's stored credits upon the user's request;

9. The transaction system of claim 1, wherein the transaction engine is further operable to charge a fee for the seller before “pay the seller according to the buyer's satisfaction” takes place.

10. The transaction system of claim 1, wherein the transaction engine is coupled to the Internet; and the transaction engine is further operable to:
receive a request to access an item from a computer coupled to the Internet;
access item database and user database to determine the contents accessible to the computer;
communicate to the computer the contents accessible to the computer in the form of one or more Web pages;
receive a numeric or equivalent satisfaction rating about the purchase from the computer coupled to the Internet within a rating period.

11. A computer implemented method for conducting transactions without return policies, comprising:
receiving fund equal to the price of an identified item from a buyer for purchasing the item;
receiving a numeric or equivalent satisfaction rating about a purchase from the buyer within a rating period and access one or more databases, the databases including user information, item information and contents, and transaction information, to record the rating;
applying a default rating to a purchase when the rating period expires and no rating has been received from the buyer;
paying the seller a portion, zero and a hundred percent included and proportional to the rating, of the withheld fund after a rating becomes available;
distributing the residual fund to one or more third parties to complete the transaction.

12. The method of claim 11, further comprising:
receiving a request for item listing, the request includes zero or more parameters;
accessing one or more databases containing item information to determine a list of items;
communicating to a user the requested item listing;

13. The method of claim 11, further comprising:
receiving a request to access an item from a user;
accessing one or more databases containing item and user information to obtain the contents accessible to the user;
communicating to the user the contents accessible to the user.

14. The method of claim 11, further comprising notifying the seller when a buyer makes a purchase.

15. The method of claim 11, further comprising actively delivering to the buyer any portion of the item's restricted contents after a buyer purchases an item.

16. The method of claim 11, wherein all third parties are charity organizations.

17. The method of claim 11, further comprising:
receiving fund from a user to be stored as buyer credits;
receiving fund from a buyer through buyer credits equal to the price of an identified item for purchasing the item;
paying the seller as seller credits a portion, zero and a hundred percent included and proportional to the rating, of the withheld fund after a rating becomes available;
paying a user any portion of the user's seller credits upon the user's request;
converting any portion of buyer credits into seller credits upon the user's request;
converting any portion of seller credits into buyer credits upon the user's request.

18. The method of claim 11, further comprising:
receiving fund from a user to be stored as stored credits;
receiving fund from a buyer through stored credits equal to the price of an identified item for purchasing the item;
paying the seller as stored credits a portion, zero and a hundred percent included and proportional to the rating, of the withheld fund after a rating becomes available;
paying a user any portion of the user's stored credits upon the user's request;

19. The method of claim 11, further comprising charging a fee for the seller before “pay the seller according to the buyer's satisfaction” takes place.

20. The method of claim 11, further comprising:
receiving a request to access an item from a computer coupled to the Internet;
accessing one or more databases to determine the contents accessible to the computer;
communicating to the computer the contents accessible to the computer in the form of one or more Web pages;
receiving a numeric or equivalent satisfaction rating about the purchase from the computer coupled to the Internet within a rating period.
